(19) United States
(12) Patent Application Publication
(10) Pub. No.: US 2020/0380450 A1
(43) Pub. Date: Dec. 3, 2020

(54) Process Management System and Its Method

(71) Applicant: Weiping Meng, Flushing, NY (US)

(72) Inventor: Weiping Meng, Flushing, NY (US)

(21) Appl. No.: 16/862,499

(22) PCT Filed: Sep. 18, 2018
(86) PCT No.: PCT/CN2018/000331

§ 371 Date: Apr. 29, 2020

(30) Foreign Application Priority Data
Oct. 31, 2017 (CN) 201711049239.8

(51) Int. Cl. G06Q 10/06; H04L 29/08

(52) U.S. Cl. CPC G06Q 10/063114; H04L 67/10; H04L 67/22; G06Q 10/063118

(57) ABSTRACT

The invention concerns process management, discloses a system and method that make duty process and management informatization, the system comprise (1) duty process and management server and database; (2) duty personel d-terminal softwares; (3) duty process timing nodes and node's site symbols; the method includes steps of (1) set duty process timing nodes and node' symbols; (2) create duty process management server and database; (3) arrange duty personel shift schedule; (4) duty personel carry duty following duty process timing nodes by scanning node symbols at nodes and report trouble to supervisors and database; (5) supervisors manage duty process in real time. The present invention is low cost and convenient, improves efficiency of duty process management and control, provides a new means for digitalized, real time duty process control modernization.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates generally to process management, particularly to a method and its system for IT-based duty management.

Currently the most common duty management systems include sign the paper, punch the lock, patrol lock, modern scan card, video surveillance, etc. each of which has advantages and focuses, however, all of which can not report and be controlled in time, all of whose ways of duty log are backward, whose costs of duty log are higher.

### BRIEF SUMMARY OF THE INVENTION

The purpose of the present invention is to fulfil IT-based management system with low cost, automatic digital duty log, easy-to-monitor of duty process.

The invention provides a systematic solution for realizing the above purposes, new IT-based duty process management and monitoring system and method, which is described in detail as follows:

A duty process management system includes (1) duty process management IT-based server (dpm-server) running duty process management software package designed on duty process management method, (2) duty personnel mobile communication terminals (d-terminal) running duty personnel software communicating with dpm-server, such as app in mobile phones or iPad, browsers in notebooks; (3) action timing and site node (action node) symbols (ats-symbols);

Said duty includes mobile duty and post duty;

Said mobile duty includes security patrols, railroad/driveroad inspection, production line lead, bus line time monitor, sanitation service, supermarket managers;

Said post duty include doormen, sentinels, gate guards of residential area, business center district, schools, supermarkets, cargo/warehouse areas, and any special control area, consultant service men of hospitals, banks;

Said duty process means a duration from on-duty to off-duty of said duty; Said action node means a specified site in a specified time in where specified actions are to be carried out;

Said action node symbol (ats-symbol) means marks standing for duty timing/site, such as QR codes, Bar codes, action node site feature photos, also with information display devices, and electrical editable devices.

Another feature of the present invention system includes,

Duty process management server (dpm-server) including duty process database (dp-database), that includes duty list, each duty is composed of a series of action nodes' information, each action node information is composed of set ats-symbol, actual ats-symbol, set action time, actual action time, a series of mini-actions, duty person, and supervisor; the ats-symbol corresponds to said ats-symbol in said system (3).

Another feature of the present invention system includes,

Action node information of action node of dp-database including action distance and details, site situation words or/and photos or/and trouble shooting log or/and supervisor instruction log; said action distance means action's distance from action node site.

Another feature of the present invention system includes,

Duty terminal (d-terminal) including information of duty process log, that's, about action node site, check-on, reports, trouble-shoots of duty person, and check-on, instructions of supervisor.

A duty process management method includes steps:

S1, create ats-symbols for actual action(check) timing and site nodes of a duty process;

S2, create dp-database in dpm-server, wherein dp-database's ats-symbols correspond to ats-symbol in S1;

S3, arrange dutys to duty persons;

S4, during duty process, duty person, at a action(check) node, uses his/her d-terminal to read ats-symbol, send the ats-symbol as actual ats-symbol to dpm-server to confirm the symbol's consistency with the ats-symbol in dp-database, to report actual check-on time, site check-on, trouble-shoot, and save these information locally in d-terminal.

Another feature of the present invention method includes,

dpm-server checks the consistency of ats-symbol and duty person identification got from duty person terminal with duty action node information in dp-database, saves ats-symbols, actual check time, check report and details, trouble-shoot, checks if the report is OK, or/and sends these information to supervisors' d-terminal.

Another feature of the present invention method includes,

duty person sends actual check node information to dpm-server, and saves these information locally in duty person's d-terminal.

Another feature of the present invention method includes,

duty person sends actual check node information to dpm-server, and the dpm-server sends trouble-shoot and relative information report to supervisor's d-terminal.

Another feature of the present invention method includes,

supervisor checks duty person report in dpm-server, or/and sends control instruction.

The advantages of the present invention are below: low cost and convenience, mobile phones as duty terminal and supervisor terminal, two-dimension codes as action node symbol, need near zero cost, no extra devices, automatic construction of duty process into digital multimedia log recorded into centered database, easy contact between supervisors and duty persons in time, improve efficiency of duty process management and control, provides a new means for duty process control modernization.

### BRIEF DESCRIPTION OF THE DRAWINGS

FIG. 1 is Schematic Diagram of Duty Process Management System;

FIG. 1-a is Schematic Diagram of Duty personnel Arrangement in dp-database;

FIG. 1-b is Schematic Diagram of Duty Person Check Node List in dp-database;

FIG. 2 is Schematic of Duty Process Management Method;

### LIST OF REFERENCE NUMERAL UTILIZED IN THE DRAWING

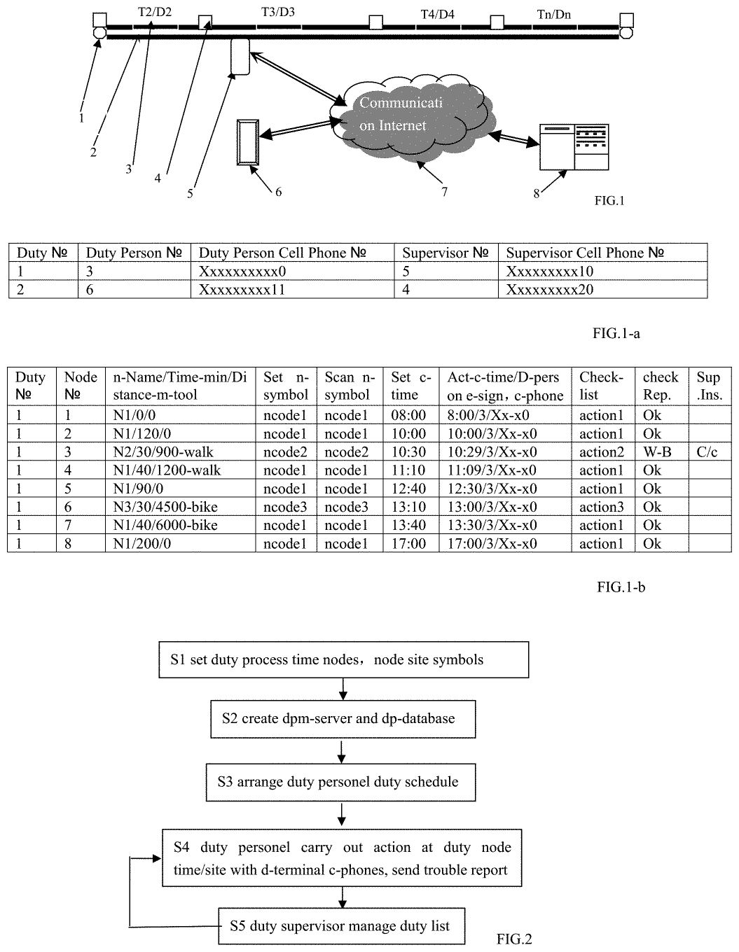

FIG. 1: 1—start point in time and start site of a duty process, as label of octagon, 2—action timing or/and sites of a duty process, as label of double bold lines, 3—numbering of action time interval and action node site of a duty process, the 1-st action time interval or/and action node site, as label of T#/D# or T#:#/D#:#, wherein T#:# means the #-th action time interval #-minutes and D#:# means the #-th action node site's distance at #-meters, 4—action node time interval or/and action node site symbol of a duty process, as label of small square, 5—d-terminal of a duty person, as label of round-corner square, staying at the 2-nd time interval or/and action node site, 6—d-terminal of a duty supervisor, as label of double rectangles, 7—communication networks, wireless and wire hubrid networks, wifi or/and mobile communication, internet networks, 8—duty process management server(dpm-server) and duty process database(dp-database), wifi or/and mobile communication server, cloud center server.

### DETAILED DESCRIPTION OF THE INVENTION

### Description of the Preferred Embodiments, Industry Applications

A detailed description of an embodiment of the invention in conjunction with the accompanying drawings:

As in FIG. 1, create a timing-actions based duty process management system, implementing a duty process with series of action, time intervals and sites, as label 1-2 of double bold lines, wherein label 1-4 of small square is for action node time interval or/and action node site symbol of a duty process, such as QR codes, T#:#/D#:# in label 1-3 of T#:#/D#:# means the #-th time interval T is # seconds, the #-th site's distance D from previous action site is # meters, for post duty, all D#:# is D#:0, for mobile duty, the #-th time interval Ts depend on duty person's using moving tool, walking, biking, motoring, duty process start with duty person's signing at time and point labeled 1-1 of small circle, duty person's actions of duty process are confirmed with duty person's d-terminal as label 1-5 of small round-corner rectangle, which sends position or/and scanned set symbol such as QR codes as small square, through communication networks as label 1-7 to dp-database of duty process management server (dpm-server) as label 1-8, and recognized confirmed, supervisors check and review multimedia duty process log in dp-database through communication networks using their d-terminals as label 1-6 of small double squares, and make instructions, the supervisors includes senior managers;

Said dpm-server and dp-database is implemented with Apache-Tomcat/mysql, said d-terminals are mobile phones with android-app and IOS-app implemented with website of “Adaptive Web Design”;

Said dpm-server and dp-database includes duty list, duty person list, supervisor list, senior manager list, duty personnel shift schedule, said lists for persons provides fields of name, mobile phones' number, order number, operation-modules for managers to arrange duty to duty personnel, auto-modules of communication that automatically transmit duty action node information about trouble shoot of duty persons to supervisors' d-terminal;

Said dpm-server includes login pages, operation pages of duty persons, supervisors, senior managers and relative operations;

Said operation pages of duty persons include (1) scan login page, automatically transmitting position; (2) page confirming received the scan information: duty person identity, action time, action site, trouble report with photos, trouble shoot report, save button to save duty person log, or return non-duty person of scan person; (3) pop out page on supervisor's instruction, and make further report;

Said operation pages of supervisors include (1) login page; (2) after-login first page: showing dutys and their action nodes information, by “click in” relative information their action-sign-in symbol, action checks are shown up, also including duty buttons, duty person button for adding, deleting, and changing duty, duty node, duty node action, duty person; (3) action pop out small page showing trouble report with photos, trouble shoot report, including input field and send-button for supervisor's instruction to duty person;

Said dpm-server operations includes (1) duty personnel login: verify password input by duty personnel; (2) duty personnel scan in: verify mobile phone number, duty node site (position) or/and action site symbol, digital or site-featured photos; (3) duty personnel action operations: receive, save trouble shoot report of duty action by duty personnel, and forward the report to supervisors' mobile phones; (4) supervisors' login: verify password input by supervisors; (5) supervisors' instruction operations: save instructions to duty trouble report by supervisors into dp-database and send the instruction to duty person d-terminal mobile phone;

As in FIG. 1-a, create duty personnel list and shift schedule in duty process management database (dp-database), each duty arrange duty personnel, supervisors based on time conflict rule, save their duty d-terminals' mobile phones numbers;

As in FIG. 1-b, create duty timing node (node) list in duty process management database (dp-database), wherein the 3-rd field(column, check list) from left side of FIG. 1-b is duty node site name(n-Name/*/*), together with the 8-th field(check list)) shows duty action(check-actions) features, that's, patrol duty, post duty, or hubrid duty, this duty node list is for post/walking-biking-patrol hubrid duty, the 1-st field (Duty N2) at left side contain an order number of a duty numbered as 1 duty by managers, the 2-nd field (Node N2) from left side contain numbers of duty nodes, which here means duty 1 has 8 duty nodes and whole duty 1 process is from duty node 1 to duty node 8, each duty node site is designed a symbol (ncode#) of QR codes, same symbol for same duty node site of different duty nodes, or/and with site-featured photos in the 4-th field (Set n-symbol), the 5-th field (Scan n-symbol) contain duty personnel's scanning in duty node site symbol (ncode#) or/and duty personnel d-terminal's mobile phone positioning, the 6-th field (Set c-time) contain set duty check-action time, the 7-th field (Act c-time/*/*) contain actual duty check-action time, or/and with scanned in duty personnel's d-terminal's mobile phone positioning, the 8-th field (check list) contain duty node actions required, the 9-th field (check-report) contain duty node trouble shoot reports, or/and with photos of trouble, or/and with voice, the 10-th field (Sup. Ins) contain instructions by supervisors;

Refer to field 3 of node name and field 4 of duty node site symbols, the duty 1 process is carried out as steps, 1) at duty node 1, duty personnel starts to work by scanning duty node 1 site symbol(ncode1=QR code 1); 2) at duty node 2, duty personnel as required to stay duty node 1 site for 2 hours by scanning duty node 1 site symbol(ncode1=QR code 1) once more to confirm; 3) at duty node 3, duty personnel as required to walk-patrol along required 900-meter-long path for 30 minutes by scanning duty node 3 site symbol(ncode2=QR code 2) to confirm; 4) at duty node 4, duty personnel as required to walk-patrol along another required 1200-meter-long path and return to duty node site 1 for 40 minutes by scanning duty node 1 site symbol(ncode1=QR code 1) to confirm; 5) at duty node 4, duty personnel as required to stay duty node site 1 for 90 minutes by scanning duty node 1 site symbol(ncode1=QR code 1) to confirm; 6) at duty node 6, duty personnel as required to bike-patrol along the 3-rd required 4500-meter-long path for 30 minutes by scanning duty node 6 site symbol(ncode3=QR code 3) to confirm; 7) at duty node 7, duty personnel as required to bike-patrol along the 3-rd required 6000-meter-long path returning to site 1 for 40 minutes by scanning duty node 1 site symbol(ncode1=QR code 1) to confirm; 8) at duty node 8, duty personnel as required to stay duty node 1 site for 3 hours and 20 minutes by scanning duty node 1 site symbol(ncode1=QR code 1) once more to confirm, and off duty at 1700 hrs;

In duty node 3 action, person discovers “window broken” with making “W-B” log, and sending out trouble report, supervisor instructs “cover-change” with “C/c”;

In this duty process, check-actions are set up as below:

Check-actions 1 {door 1, door 1's lock, window 1, window 1's lock, door 2, door 2's lock, window 2, window 2's lock, door 3, door 3's lock, others};

Check-actions 2 {door 4, door 4's lock, window 3, window 3's lock, others};

Check-actions 3 {door 5, door 5's lock, window 4, window 4's lock, wall 1/1000 meter, others}, note: all distances given here are measured from previous duty node site;

The 7-th field (check list) can be designed for special usages of embodiments, as below:

Railroad/driveroad inspection duty process, duty node actions:

Check-list11 {revetment 1/1000 meter, revetment 1/vegetation, subgrade 1, pavement 1/2600 meter, others};

Production line lead duty process, duty node actions:

Check-list21{50 workstations, on-duty, off-duty, others};

Supermarket area salesman duty process, duty node actions:

Check-list31{50 goods, goods-loss, sale-out, others};

Bus line time monitor duty process, duty node actions:

Check-list41{time control sites, lead, lag, others};

FIG. 2 shows a flowchart of duty process management, S1, design duty process timing nodes, node symbol for each duty node site, that's node symbol, such as positions, QRcodes, Barcodes; S2, create duty process management IT-based server(dpm-server) and duty process database (dp-database), wherein node symbols used in dp-database are consistency with the ones in S1; S3, arrange dutys to duty personnel; S4, as requirement of duty process timing nodes, duty personnel carry out duty node action and check report to dpm-server by scanning node symbol at each duty node site with their d-terminal mobile phones to confirm personnel's actions in time and save duty node log; S5, duty supervisors and senior managers receive and review duty log automatically sent in dpm-server to duty supervisors' and senior managers' d-terminal mobile phones, and make instructions for trouble report.

What is claimed as new and desired to be protected by Letters Patent is set forth in the following:

1. A duty process management system includes (1) duty process management IT-based server (dpm-server) running duty process management software package designed on duty process management method, (2) duty personnel mobile communication terminals (d-terminal) running duty personnel software communicating with dpm-server, such as app in mobile phones or iPad, browsers in notebooks; (3) action timing and site node (action node) symbols (ats-symbols);
Said duty includes mobile duty and post duty;
Said mobile duty includes security patrols, railroad/driveroad inspection, production line lead, bus line time monitor, sanitation service, supermarket managers;
Said post duty include doormen, sentinels, gate guards of residential area, business center district, schools, supermarkets, cargo/warehouse areas, and any special control area, consultant service men of hospitals, banks;
Said duty process means a duration from on-duty to off-duty of said duty;
Said action node means a specified site in a specified time in where specified actions are to be carried out;
Said action node symbol (ats-symbol) means marks standing for duty timing/site, such as QR codes, Bar codes, action node site feature photos, also with information display devices, and electrical editable devices.

2. A duty process management system as in claim 1, wherein duty process management server (dpm-server) includes duty process database (dp-database), that includes duty list, each duty is composed of a series of action nodes' information, each action node information is composed of set ats-symbol, actual ats-symbol, set action time, actual action time, a series of mini-actions, duty person, and supervisor; the ats-symbol corresponds to said ats-symbol in said system (3).

3. A duty process management system as in claim 1, wherein action node information of action node of dp-database including action distance and details, site situation words or/and photos or/and trouble shooting log or/and supervisor instruction log; said action distance means action's distance from action node site.

4. A duty process management system as in claim 1, wherein duty terminal (d-terminal) including information of duty process log, that's, about action node site, check-on, reports, trouble-shoots of duty person, and check-on, instructions of supervisor.

5. A duty process management method includes the steps of:
S1, create ats-symbols for actual action(check) timing and site nodes of a duty process;
S2, create dp-database in dpm-server, wherein dp-database's ats-symbols correspond to ats-symbol in S1;
S3, arrange dutys to duty persons;
S4, during duty process, duty person, at a action(check) node, uses his/her d-terminal to read ats-symbol, send the ats-symbol as actual ats-symbol to dpm-server to confirm the symbol's consistency with the ats-symbol in dp-database, to report actual check-on time, site check-on, trouble-shoot, and save these information locally in d-terminal.

6. A duty process management method as in claim 5, wherein the method includes
dpm-server checks the consistency of ats-symbol and duty person identification got from duty person terminal with duty action node information in dp-database, saves ats-symbols, actual check time, check report and details, trouble-shoot, checks if the report is OK, or/and sends these information to supervisors' d-terminal.

7. A duty process management method as in claim 5, wherein the method includes
duty person sends actual check node information to dpm-server, and saves these information locally in duty person's d-terminal.

8. A duty process management method as in claim 5, wherein the method includes
duty person sends actual check node information to dpm-server, and the dpm-server sends trouble-shoot and relative information report to supervisor's d-terminal.

9. A duty process management method as in claim 5, wherein the method includes
supervisor checks duty person report in dpm-server, or/and sends control instruction.
